(19) United States
(12) Patent Application Publication
(10) Pub. No.: US 2023/0324899 A1
(43) Pub. Date: Oct. 12, 2023

(54) SYSTEM, EQUIPMENT, AND PROCEDURE FOR MONITORING, PREDICTIVE MAINTENANCE, AND OPERATIONAL OPTIMIZATION OF VIBRATING SCREENERS

(71) Applicant: HAVER & BOECKER LATINOAMERICANA MÁQUINAS LTDA, Monte Mor (BR)

(72) Inventors: Adrian NORBERTO GAMBURGO, Monte Mor (BR); Clayton Antônio DE CARVALHO, Monte Mor (BR); Thiago Henrique BUOSO PINTO, Campinas (BR); Octávio DELIBERATO NETO, Sao Paulo (BR)

(21) Appl. No.: 18/025,122

(22) PCT Filed: Mar. 9, 2021
(86) PCT No.: PCT/BR2021/050098

§ 371 Date: Mar. 7, 2023

(30) Foreign Application Priority Data
Sep. 8, 2020 (BR) BR 10 20200182919

(51) Int. Cl. G05B 23/02; B07B 1/42; B07B 1/40

(52) U.S. Cl. CPC G05B 23/0283; B07B 1/42; B07B 1/40

(57) ABSTRACT

System, equipment, and procedure for monitoring, predictive maintenance, and operational optimization of vibrating screeners represented by an inventive solution in the industry and trade of vibrating equipment, with mechanically-driven vibration technology, with particular application to vibrating screening (Pe) equipment (Eq), aiming to monitor operational parameters, foresee the deterioration of the structural conditions of the equipment (Eq), so as to increase the interaction between maintenance and production engineering of the company, where, for such purpose, a system has been conceived whose architecture is composed of the following modules: hardware module (GHW), intelligence generation module (GI), data persistent layer module (CPD), and event management module (Ge), resulting in the conversion of the equipment (Eq)'s operational needs into a description of the performance parameters with functional analysis, synthesis, modeling, simulation, optimization, design, testing, and evaluation, integrating the performance parameters with the other requirements in the modeling process.

### TERMINOLOGY

For the purpose of providing a better understanding of the material disclosed and claimed under this invention patent, the meaning of some terms and acronyms largely mentioned in the descriptive report is presented, where:
Monitoring: for the purpose of this patent, it is deemed to be the regular observation and recording of the activities performed by a given piece of equipment. It is a routine process for gathering information on the operational variables of equipment in all its aspects.
Functional information: for the purpose of this patent, this is information concerning the variables related to the functional modules of vibrating screening equipment.
Operational information: for the purpose of this patent, this is information related to qualitative and quantitative data of productivity for vibrating screening equipment.
Maintenance: for the purpose of this patent, it is defined as the act of maintaining, sustaining, repairing, or further preserving equipment, mainly that used in mining activities. Maintenance consists of a set of actions that assist in the proper and correct functioning of equipment.

Along this line of thought, maintenance is defined in the following types: corrective, preventive, predictive, detective, and, for the purpose of this patent, the maintenance system is aimed at giving excellence to predictive maintenance.
Predictive Maintenance: it is an action carried out based on a change in the “condition” or “performance” parameter, whose follow-up occurs systemically This type of maintenance aims to prevent equipment or system failure by monitoring several parameters, enabling the equipment to continuously operate for the longest time possible.
Vibrating screening machines: specifically for use in the ore processing industry, such as coal, iron ore, among others, aiming at sorting them by size, being used in a stage following the crushing stage, for example.
KDD Process: knowledge-discovery in databases is a process for “extracting information” from the database in the search for knowledge acquisition that creates relationships of interest that are not observed by a person skilled in the art, as well as assisting in the validation of extracted knowledge.

The expected product of knowledge extraction is a relevant piece of information to be used by decision-makers, in this case, for managers of predictive maintenance plans for equipment for mining companies and steel mills, for example.
Data mining: is an English expression connected to Information Technology, whose translation to Portuguese is “mineração de dados”. It consists of functionality that gathers and organizes data, finding
   relevant patterns, associations, changes, and anomalies in it.
Machine Learning (ML): is an area of artificial intelligence where algorithms are created to teach a machine to perform certain tasks. An ML algorithm basically takes a set of input data and, based on the patterns found, generates the outputs. Each input of this data set has its “features”.
Feature: as regards artificial intelligence, is defined as a characteristic that describes an object. Any attribute of an object can be treated as a “feature”, be it a number, a text, a date, a Boolean data type, etc.
Gateway: in a free translation to Portuguese, it can be understood as a “ponte de ligação”, it refers to a piece of network hardware. A gateway is a hardware device that acts as a “gate” between two networks, which can, for example, be a router, a firewall, a server, or another device that allows information traffic to flow into and out of the network.
Network hardware: or network devices, refers to the equipment that facilitates and supports the use of a computer network, that is, they are the physical means necessary for communication to take place among the components of a network.
Vibration sensor: for vibrations to be captured, sensors which are called mechanical vibration transducers are used. There are several types of sensors, the accelerometer being the most used due to its enormous versatility.
Cloud database: the IT infrastructure (servers, databases, among others) is no longer allocated internally within an organization, which starts to use the infrastructure of a supplier having gigantic data centers.
API: is an acronym that stands for “Application Programming Interface”, which, in an allusive manner, is understood as a set of programming routines and patterns for accessing a web-based software application or platform.
Container: provides a standard way to package your application's code, settings, and dependencies into a single object. They share an operating system installed on the server and run as isolated resource processes. This allows for fast, reliable, and consistent implementations, regardless of the environment.
Front-end: are services responsible for “giving life” to the interface. They execute the part of the application that interacts directly with the user.
Back-end: are services responsible, in more general terms, for the implementation of the business rules. In a web application, these services will not interfere with the visual part of the application.
Man-machine system: is a system in which the functions of a human operator (or a group of operators) and a machine are integrated. This term can also be used to emphasize the view of such a system as a single entity that interacts with the external environment.
Person skilled in the art: according to the understanding of authors CHAVANNE, Albert & BURST, Jean-Jacques, in their work
   Droit de La Propriété Industrielle. Paris: Dalloz, 1993, p. 53-55, in an allusive manner, is a person who has the normal and average knowledge of the art that will be under analysis, who, for the purpose of this invention, is the technician who knows technical specifications for roof structures of buildings.
IPC: International patent classification.

The list of terms, technologies, and technical concepts presented in this preliminary topic must be considered for the proper understanding of this invention patent, giving the necessary descriptive sufficiency to the body of the descriptive report, and it must be used as a reference for studies in comparative analyses whether with hypothetical solutions to the prior art, that is, prior to the invention and not mentioned in this document, or products of the same nature and the same international patent classification (IPC), which are disclosed and or marketed by third parties who are not the holder(s) of this patent.

### DESCRIPTION OF THE FIGURES

In order to obtain a better understanding of the field of application, prior art, and the distinguishing characteristics of this invention patent, this descriptive report contains a set of drawings, where:

FIG. 1 is an illustrative representation of vibrating screening equipment that is the object of application of the claimed predictive maintenance system;

FIG. 2 is an illustrative representation, in the form of a photographic report, showing a crack along the entire length of the side of the body module, which could be avoided with the unprecedented artificial-intelligence-based predictive maintenance system;

FIG. 3 is an illustrative representation, in the form of a photographic report, of the side of the body module of vibrating screening equipment, showing the strategic distribution of vibration sensors on its surface, for the collection of operational parameter data;

FIG. 4a is an illustrative representation, in perspective view, of a structure sensor model, applied to the body module of vibrating screening equipment, which is part of the auxiliary equipment of the system and procedure for monitoring, predictive maintenance, and operational optimization of vibrating screeners;

FIG. 4b is an illustrative representation, in perspective view, of a vibration sensor model applied to bearings, of the drive module of vibrating screening equipment, which is part of the auxiliary equipment of the system and procedure for monitoring, predictive maintenance, and operational optimization of vibrating screeners;

FIG. 4c is an illustrative representation, in perspective view, of a gateway model, which is part of the auxiliary equipment of the system and procedure for monitoring, predictive maintenance, and operational optimization of vibrating screeners;

FIG. 5 is a representation, in the form of a block diagram, of the architecture of the system for monitoring, predictive

maintenance, and operational optimization of vibrating screeners;

FIG. 6 is a representation, in the form of a flowchart, of the process of execution of the system for monitoring, predictive maintenance, and operational optimization of vibrating screeners;

FIG. 7a is an illustrative representation, in the form of a photographic report, of the initial screen of the human/machine interface installed on vibrating screening equipment whose operation is submitted to the inventive monitoring, predictive maintenance, and operational optimization system, showing considered process parameters such as acceleration, frequency, temperature, in relation to the body, drive, and screening modules;

FIG. 7b is an illustrative representation, in the form of a photographic report, of the initial screen of the human/machine interface installed on vibrating screening equipment whose operation is submitted to the inventive monitoring, predictive maintenance, and operational optimization system, showing considered process parameters such as acceleration, frequency, temperature, in relation to the screening module, emitted by a structure sensor attached to the body module of such equipment; and

FIG. 7c is an illustrative representation, in the form of a photographic report, of the initial screen of the human/machine interface installed on vibrating screening equipment whose operation is submitted to the monitoring, predictive maintenance, and operational optimization system, showing process parameters captured from the drive module emitted by a bearing sensor attached to such operational module.

### FIELD OF APPLICATION

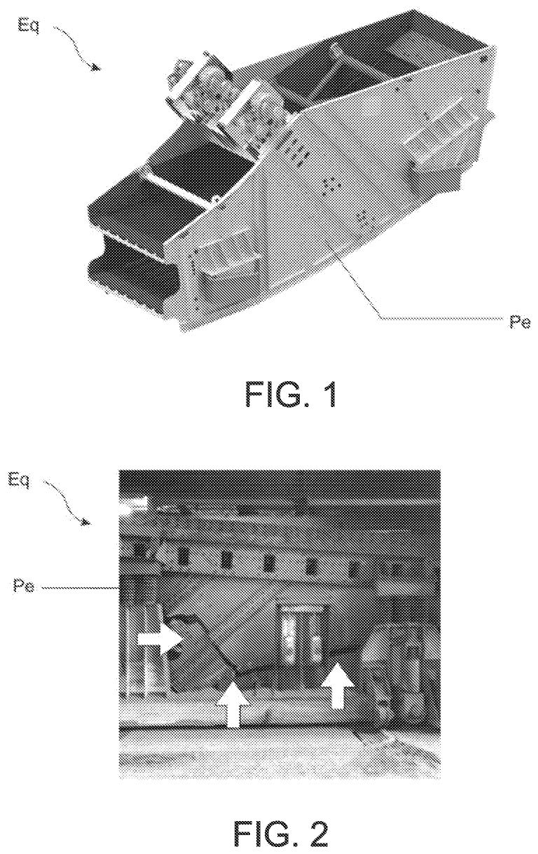

This patent for the invention mentioned in the heading and described and claimed herein refers to an inventive solution that can largely benefit the industry and trade of vibrating equipment, which is mainly used in the ore processing industry, such as mining companies, steel mills, and related industries, with particular application to vibrating screening equipment, or exciters, see FIG. 1, in varied construction configurations, being able to be applied more specifically to the following types of screeners: circular eccentric, circular free, linear free, exciter-driven linear free, elliptical, and exciter-driven elliptical.

### Demand for the Invention

In view of the field of application, the applicant identified the need to add value to conventional operational monitoring systems for mining, iron and steel industries, and related equipment, notably vibrating screening machines, which, in addition to providing operational information, start offering real-time diagnoses on it, as well as a forecast of their future conditions.

More specifically, there is a need to offer mining companies, steel mills, and industries linked to them not only operational information on equipment but also diagnoses on it, whether on its current

or future conditions, as solely examining graphs, simple alarms, and spot analyses quickly reach their limits.

In other words, this invention patent seeks to meet a demand for the solution to a problem related to the inevitable need for maintenance of vibrating screening (and related) equipment that has long been an object of desire in the mining and iron and steel industries, and it will take place by conceiving a system whose architecture makes it feasible to acquire “predictive models” capable of predicting deterioration of the structural conditions of this type of equipment and, in addition, listing the most likely failure modes that are associated with such conditions, giving feedback to decision-makers in conducting maintenance of the equipment in an industrial facility (mining, steel and iron, etc.), aiming to maximize the hour/machine ratio.

### Invention Requirements

In line with the demand for the invention, the applicant designed the “SYSTEM, EQUIPMENT, AND PROCEDURE FOR MONITORING, PREDICTIVE MAINTENANCE, AND OPERATING OPTIMIZATION OF VIBRATING SCREENERS”, in more detail, a system, equipment, and procedure for obtaining and interpreting historical and real-time functional and operational information on equipment of mining companies, iron and steel mills, and related industries, applied to support decision-making in predictive maintenance plans.

This system is provided with novelty associated with inventive

step, as it does not result, in an obvious or evident way, from other previously existing techniques, bringing advantages from the industrial, commercial, and technical points of view.

In addition, the “invention” has industrial applicability, is economically viable, and, therefore, it meets the patentability requirements, notably as an invention patent, as provided for in articles 8 and 13 of Law 9,279.

### Fundamentals of the Technique

In order to provide veracity and consolidate the context explained in the introductory section, an explanation on the state of the art for screening equipment applied in mining activities will be presented, where, after a critical analysis of it is carried out, once it is evaluated by persons skilled in the art, it will be possible to identify its limiting aspects in relation to the difficulty in scheduling maintenance as effectively as possible, thus consolidating the identification of the previously mentioned demand.

a. Types of vibrating mechanisms: in the mining area, the use of crushed ore screening equipment applied to triple- and dual-axis screeners is known, and for the purpose of this patent, the renowned model with a dual-axis mechanism was chosen, which is now studied in detail, where two distinct types of construction configuration are known to be used, namely:
(i) Mechanism with dual axes along the screener width: this is a technology largely used by the industry mechanism of this kind, whose construction features can be found in countless patent documents, among which the following ones worth being mentioned:
   Doc. 1 GB2034437A, published on Sep. 11, 1979;
   Doc. 2 U.S. Ser. No. 06/024,210, published on Feb. 15, 2000; and
   Doc. 3 EP1439139, published on Jul. 21, 2004.
(ii) Mechanism with axes superimposed on the screener structure: its unique mounting location eliminates the need to disassemble the screening equipment itself, where the vibrating mechanism can be understood as being modular, and it can be disassembled independently for maintenance purposes. A study of the state of the art reveals that its construction features can also be found in countless patent documents, among which we mention:
   Doc. 4 U.S. Pat. No. 3,796,299 published on Apr. 12, 1974;
   Doc. 5 WO1996008301A1 published on Mar. 21, 1996; and
   Doc. 6 WO1998016328A1 published on Apr. 23, 1998.

b. Construction Concept of Vibrating Screeners:

In general, this equipment will be described in its construction features, in the form of functional modules, which are listed below:
Body module: is a module that provides structure to the operational modules, consisting of side plates, reinforcing plates, cross members, longitudinal beams, bridge, etc.;
Suspension module: is a structural module that allows the screener to be mounted on a place or structure through support on spring elements that will attenuate the dynamic loads transmitted;
Static base module: is a structural module,
   consisting of structural bases that support the physical structure of the screener and the electric motor of the motor module;
Motor module: is an operational module, consisting of an electric motor;
Transmission module: is an operational module consisting of axes and couplings, which can also have pulleys and belts for adjusting the operating speed of the vibrating screening equipment;
Drive module: is an operational module consisting of the mechanism that is meant to provide the vibration of the vibrating screening equipment, whose types can be axis with unbalanced masses, eccentric axis, exciters, etc.; and
Screening module: is an operational module consisting of an assembly of at least one screen that effectively sorts ore particles (for example) by size, and the smallest particles pass through its apertures and the largest ones are retained on the surface of the screens.

c. Environmental and Operational Conditions to which the Equipment is Subject:
c.1 Environmental conditions: to a large extent, vibrating screening equipment is subject to weather conditions, such as rainfall, sunlight, etc., leading, among other harmful effects, to corrosion of the component parts of the structural and operational modules.
c.2 Operational conditions: because of its application, vibrating screening equipment is subject to intense abrasive wear due to the impact of the ore
   particles sieved, which is also subject to corrosion, which, in this case, is caused by the moisture inherent in the processed material itself (ore) or the supply of water that in some cases is added to assist in sorting the ore particles previously sieved.

However, ore processing experts point out that there are still some special cases in which the operating conditions of the screening equipment are even more extreme, such as:
(i) Low ambient temperature: screeners for oil extraction in Canada operate in environments where the ambient temperature is extremely low, which can reach, for example, −40° C.;
(ii) High ambient temperature: iron ore pellet screeners in Iran operate in an environment where the ambient temperature is extremely high and can reach, for example, 50° C.;
(iii) Materials that are sieved at high temperatures: Hot Sinter screeners receive materials to be processed where the temperature is around 900° C.;
(iv) Special processes: an industrial unit, a pelletizing plant, in the municipality of São Luís—State of Maranhão, Brazil, inserts hot air at a temperature of 500° C. in the protective screen in order to reduce its processing moisture, aiming to mitigate, in particular, corrosion on the components of vibrating screening equipment.

d. Identification of the most fragile modules: of the structural and operational modules listed above, the ones that require the most attention in relation to maintenance are:
structural module and suspension module have their component parts most subject to intense fatigue from the intrinsic cyclical efforts of the operational kinematics characteristic of this type of equipment than intense vibrating motion;
screening module where screens are in direct contact with the sieved materials and therefore undergo intense wear due to abrasion and impact.
drive module where its component parts are subject to constant wear due to friction, more specifically friction from the movements between the internal components of the bearings and gears.

d. Conventional predictive maintenance: inspections to define a predictive maintenance plan for vibrating screening equipment take into account:
(i) visual inspection of the structural and operational modules of the equipment;
(ii) analysis of vibration of the equipment as a whole, in which vibration sensors (a maximum of 08 units of these are usually specified) are strategically placed on the side plates of the vibrating screening equipment whose function is collecting data, which will be stored and used to generate an automatic report on the dynamic conditions of such equipment.

Based on the data obtained on acceleration levels of each strategic point, comparisons between left and right, and between feeding and unloading, it is possible to classify the equipment as good, acceptable, or bad. Finally, the technician who is visiting the site correlates the report on the dynamic condition generated

from the visual inspection of the equipment, and establishes what actions should be taken and when. In other words, mechanical interventions are suggested, whether with respect to maintenance or changes in the project or operational conditions, within a certain estimated time horizon.

It is important to emphasize that the equipment classification, based on the dynamic condition report, as good, acceptable, or bad, is based on experience acquired over time with vibrating equipment. It is known that these are designed to vibrate and cause the screening effect in two axes, which are called X and Y. Therefore, any excessive or significant vibration on the Z axis is seen as indicative of a problem since the equipment has not been designed to withstand such vibrations in this regard.

e. Problems with Conventional Maintenance:
(i) In the case of periodic maintenance scheduling, its efficiency is quite low, as there will be cases in which predictive maintenance will be unnecessarily performed, due to the equipment being in proper conditions.

In addition, there will also be cases in which the equipment will somehow fail in the intervals between maintenance services, due to the lack of constant/regular monitoring of its dynamic conditions.
(ii) Regarding the use of visual inspections and measurements of the dynamic condition of the equipment, whether spot or regular by some monitoring system available on the market, it is possible to state that they are also not effective for good predictive maintenance planning, since they do not anticipate problems that are likely to occur with such equipment.

In other words, the available methods produce only snapshots of the equipment's functionality, providing information on its current state, having little potential to avoid unwanted downtime or even catastrophic events.

In addition to that, the estimated useful life of the equipment does not rely on a scientific method to be calculated as well, that is, it is based on the experience of the technicians involved in the analysis of the readings obtained.

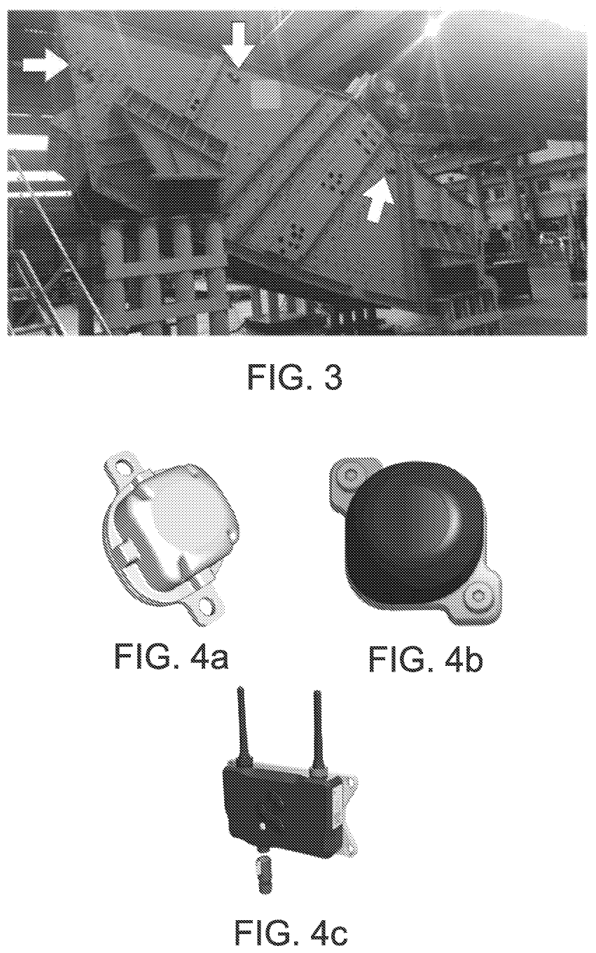

In view of the restrictive aspects listed above, one of the consequences lies in one being not able to foresee the occurrence of structural non-conformities in the equipment, for example, the formation of cracks along the entire length of the side of the body module (m1), see FIG. 2.

### Proposal of the Invention

a. Objectives:

Three main objectives are defined and described below in ascending order of complexity and value generation for the customer:
(i) Monitor Operational Parameters:
   vibration and temperature parameters for the set of bearing components of the drive module (m6), which are collected by means of vibration sensors strategically mounted on these bearings;
   amplitude, rotation, and acceleration parameters regarding the vibrating screener structure, of the screening module (m7), which are collected through the sensors previously installed on the screener structure;
(ii) Machine learning: employ machine learning algorithms with expert systems capable of predicting the deterioration of the structural conditions of the vibrating screening equipment and, in addition, listing the most likely failure modes that are associated with such conditions.
(iii) Increase the interaction between maintenance and production engineering: with the knowledge obtained at the previous levels (i) and (ii), the system will make suggestions for adjusting the operational parameters for both drive module bearings (m6) and screening module screens (m7), with the purpose of extending the equipment's useful life, taking predictive maintenance and production to new levels of performance.

b. Features: in order to make the objectives of this invention patent feasible, they were divided into three categories: system as a whole, equipment (hardware), and system execution procedure, and the great distinguished feature that allows one to predict problems in equipment and, thus, to increase efficiency in determining predictive maintenance, lies in the use of artificial intelligence technology in the “information generation stage” of the aforementioned procedure.

### DETAILED DESCRIPTION

The following detailed description should be read and interpreted with reference to the drawings, process flowcharts, and block diagrams shown here, and it is not intended to limit the scope of the invention, which is restricted only to what is

explained and defined in the claims section.

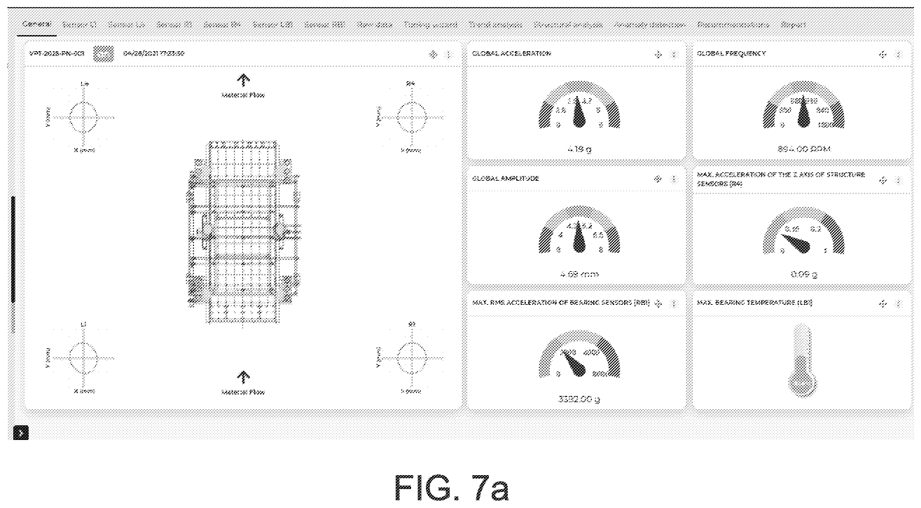

a. System architecture: as shown in FIG. 5, the system consists of:
A hardware module (GHW), composed of many sensors, notably structure sensors (Se1) and bearing sensors (Se2), a gateway (Gw), which will collect the data from the sensors, and a router (Rt) that will receive the data from the gateway (Gw) to send it to the cloud, called internet gateway (Gwi).

In a preferred embodiment, the sensors (Se1) and (se2) are specified as being wireless and with an IP69K degree of protection, said characteristics being suitable for the environments in which they will be installed.

The gateway (Gw) and the router (Rt), which will collect information from the sensors (Se1) and (Se2) to send it to the internet gateway (Gwi) are also specified as being wireless and have adequate protection, IP65 and IP67 respectively, in addition to being equipped with long-range antennas, since the signals from mobile networks can be weak in some mining sites. It is important to note that the gateway (Gw) has also output via physical cable specified for communication with local supervisory software through a Profibus protocol.
Traffic management module (GT): responsible for managing the traffic of information from the central management module in the cloud (CG) in different locations, (Loc1), (Loc2), (Loc3), . . . (Locn), supported by the container registry, (Rc), and front-end services (Sfe) and back-end (Sbe) services.
Intelligence generation module (GI), composed of APIs (Application Programming Interfaces) that enable the transmission of information between the hardware module (GHW) and the computer services responsible for both calculating and manipulating data necessary for the proper functioning of the system, back-end services (Sbe) and the experience of the user when using it, front-end services (Sfe). These computational services also include the machine learning algorithms, or machine learning services (MAQ), and the repositories or databases (Bd) necessary for the storage and flow of information in the system;
Data persistent layer module (CPD); and
Event management module (Ge): receives the input of information from the intelligence generation module (GI), to then assist in the decision-making process through the scheduling of maintenance events for the equipment monitored in the geographic locations (Lon) where it is distributed.

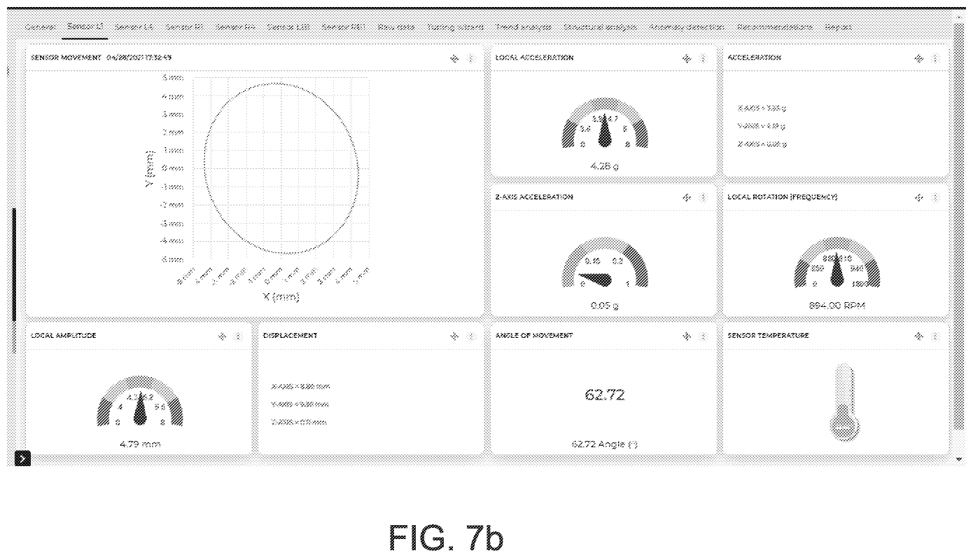

b. System Operational flowchart: the operating logic of the system whose architecture is revealed in FIG. 5 is described in detail in the flowchart of FIG. 6.

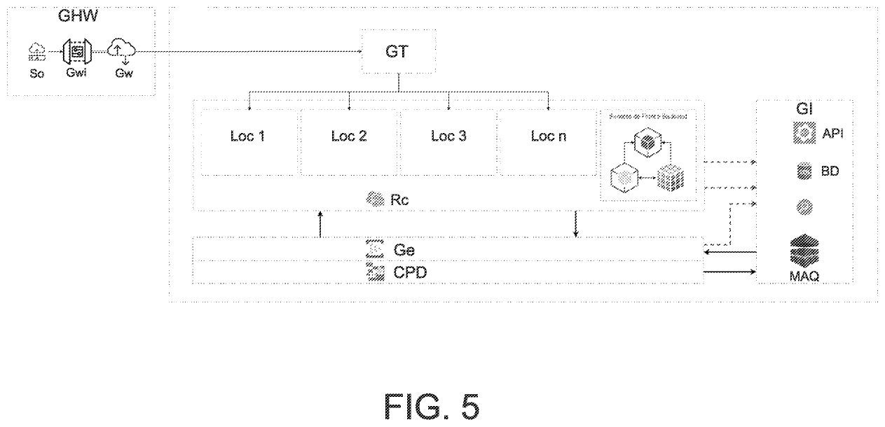

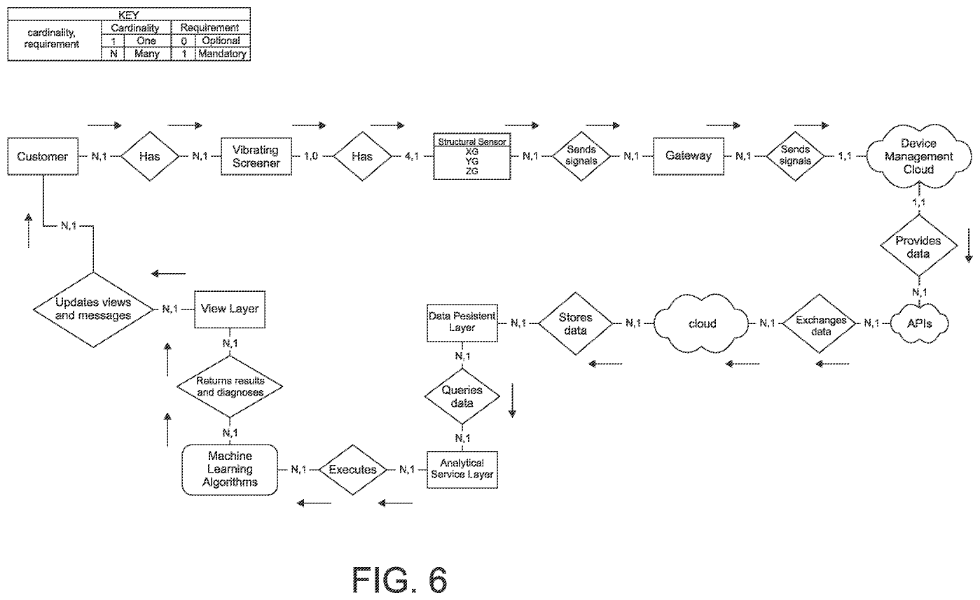

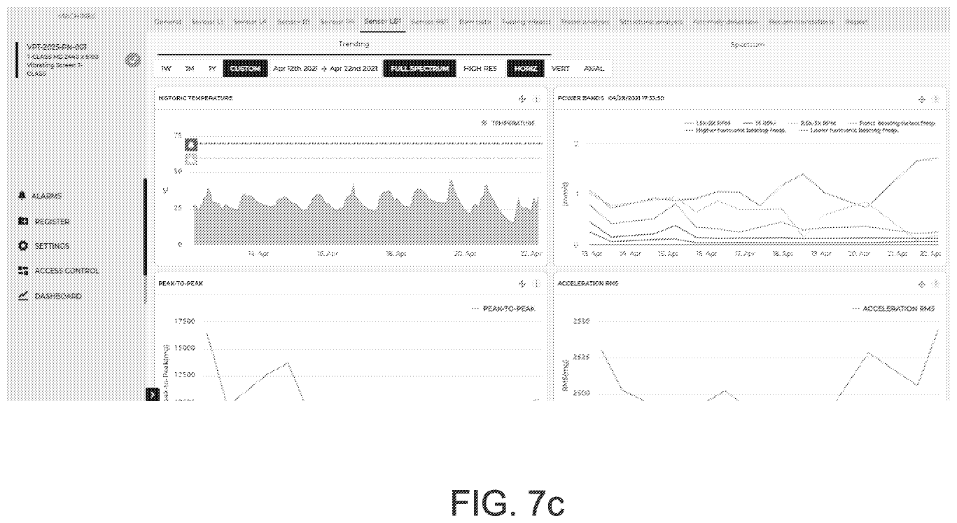

Basically, every 5 minutes, the sensors (Se1) and (Se2) strategically installed on the equipment (Eq), see FIGS. 3 and 7a, send information to the gateway (Gw), which in turn, transmits it to the database (Bd) in the cloud (CG), which in turn treats and analyzes it, resulting in the delivery of information on the monitored equipment to the customer owning it, via the communication interface, see FIGS. 7a, 7b, and 7c.

Historical performance data for equipment such as vibrating screeners, for over 20 years, was extracted and, together with interviews with persons skilled in the art who work in detail with such type of equipment (Eq), was used in the following stages of KDD (Knowledge Discovery in Databases) processes:
Stage 1. Data understanding:
Substage 1.1. Evaluation of the databases (Bd) available in the intelligence generation module (GI);
Substage 1.2. Evaluation of the information contained in the database (Bd) fields;
Substage 1.3. Visual evaluation of the basic relationships between the attributes presented;
Stage 2. Data preparation:
Substage 2.1. Detection of outliers, errors, duplicate data, irrelevant fields, and estimation of missing data;
Substage 2.2. Creation of new attributes/data transformation, if needed;
Stage 3. Selection and application of Machine Learning methods to extract “knowledge” from data;
Stage 4. Selection and application of forecasting algorithms to predict the value of important variables;
Stage 5. Detailed design, which consists in converting the operational needs of the customer owning the equipment (Eq) into a description of the performance parameters of the vibrating screeners (Eq) through functional analysis, synthesis, modeling, simulation, optimization, design, testing, and evaluation, integrating the performance parameters with the other requirements in the modeling process.

The choice of the preferred embodiment of the invention claimed in this patent, described in this detail section, is provided by way of example only. Alterations, modifications, and variations can be carried out for any other preferred embodiments of the inventive system, and such alterations can be conceived by those who are skilled in the art without, however, diverging from the objective revealed in this patent application, which is exclusively defined in the claims below.

It can be seen from what has been described and illustrated that the “SYSTEM, EQUIPMENT, AND PROCEDURE FOR MONITORING, PREDICTIVE MAINTENANCE, AND OPERATIONAL OPTIMIZATION OF VIBRATION SCREENERS” hereby claimed is in accordance with the rules governing the invention patent under the Industrial Law Property, and, therefore, it deserves, based on the foregoing and as a result, to be granted due privilege.

1. A system, equipment, and procedure for monitoring, predictive maintenance, and operational optimization of vibrating screeners, wherein in vibrating screening (Pe) equipment (Eq), in particular its structural module (m1), suspension module (m2), screening module (m7) and drive module (m6), among others, are submitted to the system/equipment; the system's architecture comprising:
hardware module (GHW), composed of many sensors, notably structure sensors (Se1) and bearing sensors (Se2), a gateway (Gw), which will collect the data from the sensors, and a router (Rt) that will receive the data from the gateway (Gw) to send it to the internet gateway (Gwi);
intelligence generation module (GI), composed of APIs (Application Programming Interfaces) that enable the transmission of information between the hardware module (GHW) and the computer services responsible for both calculating and manipulating data necessary for the proper functioning of the system;
traffic management module (GT): responsible for managing the traffic of information from the central management module in the cloud (CG) in different locations, (Loc1), (Loc2), (Loc3), . . . (Locn), supported by the container registry, (Rc), front-end services (Sfe), and back-end (Sbe) services;
the intelligence generation module (GI) is also responsible for back-end services (Sbe) and the experience of the user when using it, front-end services (Sfe), including machine learning algorithms, or machine learning (MAQ) services, and the repositories or databases (Bd) necessary for storage and flow of information in the system;
data persistent layer module (CPD); and
event management module (Ge): receives the input of information from the intelligence generation module (GI), to then assist in the decision-making process through the scheduling of maintenance events for the equipment monitored in the geographic locations (Lon) where it is distributed.

2. The system, equipment, and procedure for monitoring, predictive maintenance, and operational optimization of vibrating screeners according to claim 1, wherein, in a preferred embodiment, sensors (Se1) and (se2) are characterized in that they are specified as being wireless and with an IP69K degree of protection.

3. The system, equipment, and procedure for monitoring, predictive maintenance, and operational optimization of vibrating screeners according to claim 1, wherein, in a preferred embodiment, the gateway (Gw) and router (Rt), are characterized in that they are specified as being wireless with IP65 and IP67 protection, respectively, in addition to being equipped with long-range antennas.

4. The system, equipment, and procedure for monitoring, predictive maintenance, and operational optimization of vibrating screeners according to claim 3, wherein, alternatively, the gateway (Gw) is characterized in that it has output via physical cable specified for communication with local supervisory software through a Profibus protocol.

5. A procedure for monitoring, predictive maintenance, and operational optimization of vibrating screeners, based on the system/equipment according to claim 1, wherein sensors (Se1) and (Se2) strategically installed on the equipment (Eq), send information to the gateway (Gw), which in turn, transmits it to the database (Bd) in the cloud (CG), which in turn treats and analyzes it, resulting in the delivery of information on the equipment (Eq), and, based on the collection of historical performance data for vibrating screening equipment, fed the database (Bd) used in KDD—Knowledge Discovery in Databases, which operate by stages, where:
Stage 1. Data understanding:
Substage 1.1 Evaluation of the databases (Bd) available in the intelligence generation module (GI);
Substage 1.2 Evaluation of the information contained in the database (Bd) fields;
Substage 1.3 Visual evaluation of the basic relationships between the attributes presented;
Stage 2. Data preparation:
Stage 3. Selection and application of Machine Learning methods to extract “knowledge” from data;
Stage 4. Selection and application of forecasting algorithms to predict the value of important variables;
wherein Stage 2 Data preparation includes:
Substage 2.1 Detection of outliers, errors, duplicate data, irrelevant fields, and estimation of missing data;
Substage 2.2. Creation of new attributes/data transformation, if needed;
Stage 5. Detailed design, which consists in converting the operational needs of the customer owning the equipment (Eq) into a description of the performance parameters of the vibrating screeners (Eq) through functional analysis, synthesis, modeling, simulation, optimization, design, testing, and evaluation, integrating the performance parameters with the other requirements in the modeling process.
